(19) United States
(12) Patent Application Publication
(10) Pub. No.: US 2026/0214362 A1
(43) Pub. Date: Jul. 23, 2026

(54) SYSTEM AND METHOD FOR PON NETWORK ACCESS PROVISION WITH AUTOMATIC RESOURCE DISCOVERY AND ALLOCATION

(71) Applicant: Altice Labs, S.A., Aveiro (PT)

(72) Inventors: Mónica Ana Catarina SOARES, Aveiro (PT); Franco Pedro Miguel SARAGOÇA, Aveiro (PT)

(21) Appl. No.: 19/141,005

(22) PCT Filed: Dec. 21, 2023
(86) PCT No.: PCT/EP2023/025551

§ 371 Date: Jun. 18, 2025

(30) Foreign Application Priority Data
Dec. 21, 2022 (PT) 118423

(51) Int. Cl. H04Q 11/00

(52) U.S. Cl. CPC H04Q 11/0067; H04Q 2011/0064

(57) ABSTRACT

This invention is designed considering connectivity providers that are deploying FTTH networks based on PON technologies. This invention describes a proposition for a provisioning process to be used that can cover several network scenarios and management approaches, and it is also independent of the field processes deployed for service provision, touching them only where it provides agility and adaptability for last minute changes due to very common real world field force hazards. A system and method are provided to support a scenario where PON network access services can be provisioned through processes that are as much as possible automatized, without the need for detailed physical and topological inventory information, with tolerance for last minute changes due to network development or service provision field force constraints and doing so without losing control on network resource usage and the capacity for management level network control and optimization.

### FIELD OF THE INVENTION

The present invention is enclosed in the area of communications. Particularly, invention refers to a system and a method adapted to perform automatic discovery and allocation of network resources for supporting customer passive optical networks (PON) access, with limited prior knowledge of the physical network topology and avoiding common human errors on network inventory and inaccuracy on information collected from field force.

### PRIOR ART

Passive optical networks (PON), have been the primary choice for operators around the world to provide Fiber-to-the-Home (FTTH) network access to their customers, representing the vast majority of fibre accesses provided today. The most common network technologies on this domain are Gigabit Passive Optical Network (GPON) and Ethernet Passive Optical Network (EPON), and their descendant technologies (e.g., XGSPON) that provide higher throughputs.

In order to be able to assign network resources, optimize network usage and keep track of services and the resources supporting them, several network provisions processes have been developed. These processes often rely on a thorough and very accurate inventory of the network, which demands for very strict network construction processes without margin for human error, and little capacity for adjustments caused by hazards encountered during field force activities. These types of processes usually end up generating huge operational constraints, where inventory errors cause provision processes to fail, most of the times when technicians are on the field or at customer premisses, punishing cots and customer experience.

Another approach sometimes used is to try to automatize as much as possible on the network control plane, achieving an almost plug&play (P&P) network configuration. Such approach is not possible with all PON technologies (e.g. GPON), and in cases where it is possible, it leads to a poorly optimized network, and with no control for what gets provisioned or where, leading to overloaded network branches with traffic demands, while other branches are underused.

Both these scenarios get aggravated by the fact that PON networks, as the name says it, are passive networks, build on passive network elements, that can't be managed automatically, don't get provisioned, and don't report.

### PROBLEM TO BE SOLVED

The present invention intends to simplify the service provider's processes, by avoiding errors or automating manual activities. Such is achieved by disclosing a new system and method for network access provision.

The method is automatic, does not require detailed network inventory information, is also tolerant on human error and supports last minute changes for network construction and service provision processes. Furthermore, the invention helps mitigating field work possible hazards while keeping control on which services are provisioned, where they are provisioned, and assuring the services have the required resources provided from the network so their customer service-level agreements are met.

### SUMMARY OF THE INVENTION

The invention discloses a method for provisioning PON access networks, that does not need to rely on a thorough or extremely accurate inventory of the passive components of a PON network and its connections. The invention instead focuses in giving some control to the network operator while also providing accurate information about the resources assigned to each customer access.

The challenge on the scenario being addressed is that a PON is a shared medium network, where several online network terminals (ONTs) can be connected to a single port of the optical line terminal (OLT). Usually, a ONT represents the network termination point at a customer premises, so as consequence the ONT usually identifies the customer too. This demands mechanisms to assure that the traffic from each customer is correctly identified, prioritized, and secured. PON networks define all protocols and processes to assure this and the consequence for management systems is that an ONT, or often, a customer, is identified by its serial number. Hence, among the challenges of the provision process, one is to correctly map the ONT serial number into a customer, and into an OLT PON port. One example that can complicate the process is that, for convenience and logistics simplicity, the ONT serial number is usually known when a technician gets to the customer premises and assigns one that he has on his possession.

In a particular embodiment of the invention, the system and method is adapted to correctly assign an ONT to a customer and a PON port at an OLT autonomously, i.e., without requiring accurate inventory of the access network. Preferably, the method is only provided access to the list of OLTs covering a geographical area, so that the method described may be optimized by being directed to the most probable resources. In turn, following the provision process, the method is adapted to update the inventory with a more accurate mapping of the resources (ONT, OLT, PON ports) to each service in particular. Said optimization provides important information for network planning and traffic engineering.

Advantageously, the method defined on this invention is based on two processes that can be used independently to the particular conditions of each ecosystem or combined together whenever better results are possible.

In the preferred embodiment of the invention, the first process relies on the automatic mapping of an OLT and a ONT, provided by the active components of a PON network. Advantageously, when an unknown ONT reaches an OLT, an alarm is generated to report a new unknown customer. This alarm is used to determine the customer is located in the PON network.

In the same preferred embodiment of the invention, as opposed to the first process, the second process acts independently from the PON network, i.e., is not provided with any information by the active components of the network. Second process, when a new customer is installed and detected by the provisioning systems who are usually also orchestrating workforce activities, it launches a discovery process on the OLTs that are on the same region as the customer. The system uses the customer address and the network inventory to select the OLTs where the customer ONT is likely to come up. Pooling all the OLTs on the geographical region should provide the PON port where the ONT came up. Advantageously, second process is intended to be used on situations where the first process alone is not reliable or as a fallback mechanism for the first process.

Information retrieved by the execution of this method may be used in turn as feedback for the inventory, so each provision process that is run may contribute to the accuracy of the inventory.

### DESCRIPTION OF FIGURES

FIG. 1 shows a diagram representing the network and provision system environment in which some embodiments of the invention may be implemented.

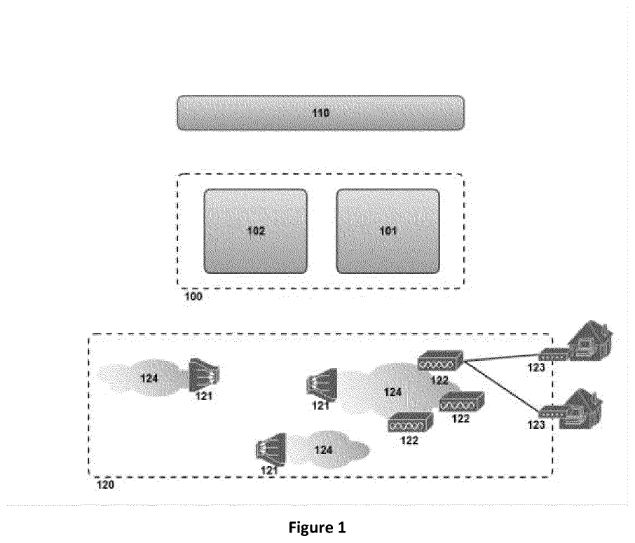

FIG. 2 shows a diagram representing the initial part of a common provisioning process, assuring the service feasibility analysis, the instantiation of the provisioning order, and the connection of the ONT to the operator network. It is essential to gather the ONT serial number, but the way it is obtained, or the way the ONT reaches the customer premises can be materialized on any way possible (workforce, operator store, mail expedition, etc.).

FIG. 3 shows a diagram representing the first process which is based on an event that the OLT sends to the provisioning system with the indication of the PON port where the ONT came up. It also shows the way resource allocation and network configuration is performed.

FIG. 4 shows a diagram representing the second process which can be a fallback mechanism for the first process or used when the PON network has no ability to send events to the provisioning system. It is based on a discovery process targeting the OLTs that are in the same geographical areas as the customer address.

### DETAILED DESCRIPTION

The following description is presented to enable any person skilled in the art to build and use the invention. Various modifications to the disclosed embodiments will be readily apparent to those skilled in the art, and the general principles defined herein may be applied to other embodiments and applications without departing from the scope of the present invention. Thus, the present invention is not intended to be limited to the embodiments shown.

A general and preferential embodiment of the system (100) comprises at least two main functional blocks: the provision orchestrator (101) and a network communications interface (102), namely a network and services inventory. Said system (100) is further comprises means of exposing the Application Programming Interfaces (APIs) towards the operator's business support system (BSS) (110). The BSS (110) uses such APIs for service feasibility requests and to issue service provisioning orders. The PON access network (120) is composed by OLTs (121) that support PON segments (124) represented here as a cloud to emphasize that its internal topology is not relevant for the system described. That PON segments usually terminate at physical access points (122) where fibre fusion is performed and the last fibre segment that ends at customer premises is connected. At the end of the PON segment we have the ONT (123), that is terminating the operator's network and bridging into the customer network.

Yet the preferential embodiment of the method comprises a series of events that happen in both processes in an initial phase. The BSS (210) is adapted to perform the service feasibility analysis to ensure a particular service is viable at a specific customer address. The service inventory (202) is responsible for assessing viability of the service and responds accordingly. If the service is viable, a provisioning order can be instantiated on the provision orchestrator (201).

After this several optional activities, that will ensure that an ONT reaches the customer premises, and its serial number is known by the provision orchestrator (201). Examples of such activities are often related to the way the operator works, interfaces with its customers or the way it sells its services.

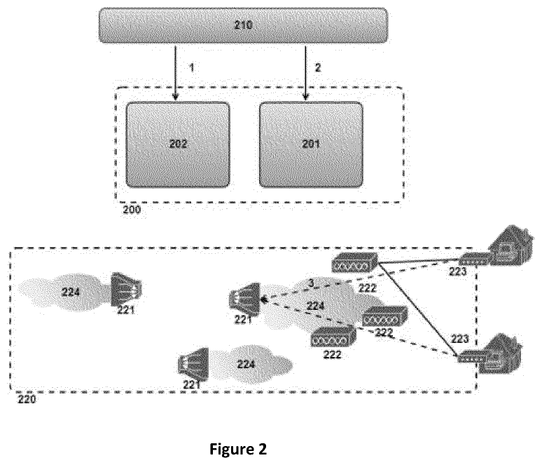

An alternative embodiment of the invention, in the event case an ONT is connected and boots at the customer's home (223), said invention is adapted to automatically start a network self-discovery process through the PON network (220) to the OLT (221). Such process is referenced as 3 in FIG. 2. Advantageously, the OLT gathers the ONT serial number, and is capable of identifying on which one of its PON ports the ONT came up.

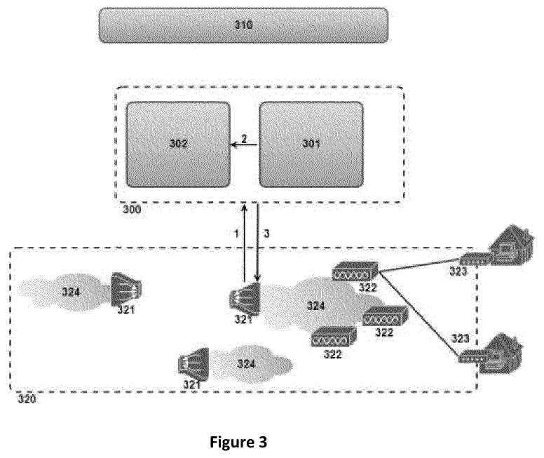

FIG. 3 depicts an alternative embodiment of the system, where the sequence of events in the case of the first process described in this invention. In this process, if an unknow ONT (323) is detected on an OLT (321), the system automatically sends an event to the provisioning system (301) to inform that the ONT (323) came up in a PON port of that OLT (321). Such process is referenced by the sign 1 in FIG. 3. This mapping is updated to the network interface (302) with accurate information about the active resources (ONT serial number, OLT PON ports) that are supporting the service, as depicted in process 2 in FIG. 3.

The provisioning orchestrator (302) had acquired the ONT serial number, similarly to the previous embodiment, and is adapted to activate the service at the detected customer (123). Said activation process captures the logical resources allocated by the inventory (302) such as ONT ID or the VLAN.

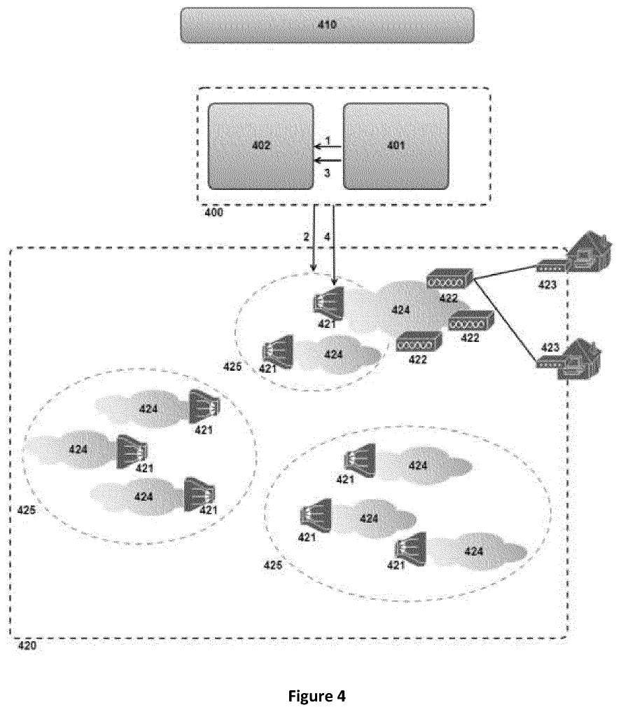

Yet another embodiment of the inventio is shown in FIG. 4. Such embodiment is representative of a scenario where the automatic discovery mechanism that relies on the active components of a PON network fails. Said embodiment acts as a fallback mechanism for the first failing process, when the OLT (421) event is not received on the provisioning system (401) or used when the PON network has no ability to send events to the system (400). If system (400) does not receive the OLT (421) event due to inability of the OLT to send notifications or due to errors that may occur in this process, the system (400) is further adapted to access the inventory system (402) and query the OLTs (421) on the same geographical region (425) as the customer (423), via a discovery process is started on those OLTs to find the PON Port where the ONT (423) came up. Gathered information will be used to enrich the provision process that is being executed by the provision system (400). The inventory (402) is updated with the gathered information about the active resources (ONT serial number, OLT PON ports) that are supporting the service.

1. A system for PON network access provision with automatic resource discovery and allocation characterized for comprising two main functional blocks:
provision orchestrator; and
network communications interface;
wherein the system is adapted to receive information by active components of the PON and discover an unknown ONT connected to the network, the network communications interface is adapted to locate the unknown ONT connection.

2. The system according to claim 1 characterized for the system further comprising a user communications interface adapted to expose a system operator with gathered information.

3. The system according to claim 1 characterized for comprising detections means adapted to detect a new OLT connection at home of a customer and automatically gather an ONT serial number and which PON ports the ONT was detected.

4. The system according to claim 3 characterized for the network communications interface being further adapted to map and store the ONT-OLT and its related active resources.

5. The system according to claim 3 characterized for the network active resources being the ONT serial number and the OLT PON ports.

6. The system according to claim 4 characterized for comprising means of querying an inventory system for OLTs on a same geographical region as a particular customer and for detecting a PON Port where the ONT was detected.

7. A computational method for automatic resource discovery and allocation in a PON characterized for comprising steps of:
detecting a new connection ONT connection;
automatically mapping the ONT connection to an OLT;
storing said mapping; and
querying stored ONT-OLT mappings to locate a new ONT connection.
